(19) United States
(12) Patent Application Publication
(10) Pub. No.: US 2008/0080960 A1
(43) Pub. Date: Apr. 3, 2008

(54) Container rigid adaptor pole

(75) Inventors: Stephen Lynn Zeller, Phoenix, AZ (US); Billy Joel Adams, Alameda, CA (US)

Correspondence Address: Michael E. Dergosits;Suite 1450, Four Embarcadero Center, San Francisco, CA, 94111, US

(73) Assignee: One Way Lease, Inc.

(21) Appl. No.: 11/522,174

(22) Filed: Sep. 15, 2006

(51) Int. Cl. B65G 1/00

(52) U.S. Cl. 414/284

(57) ABSTRACT

An adaptor pole for use with an ISO marine container. The marine container is characterized as having a top, bottom and connecting sidewalls and further having at least one corner casting characterized as having openings in its top and at least one side thereof. The adaptor pole is made up of an elongated cylindrical member having a proximal end and a distal end, an abbreviated cylindrical member joined substantially perpendicularly to the elongated cylindrical member proximate the proximal end thereof, a stabilizer plate located proximate and parallel to the abbreviated cylindrical member and a barrier plate bridging the stabilizer plate and abbreviated cylindrical member. The adaptor pole is sized to enable the proximal end of the elongated cylindrical member and abbreviated cylindrical member to be removably secured within the corner casting while the stabilizer plate resides thereon to maintain the orientation of the elongated cylindrical member with respect to the ISO marine container.

### TECHNICAL FIELD

The present invention is directed to an adaptor pole for use with an ISO marine container which is composed of various elements to enable the adaptor pole to reside within a corner casting of the ISO marine container and to provide a pole extending, preferably vertically, to support various elements such as signage identifying the container and its contents.

### BACKGROUND OF THE INVENTION

ISO marine containers are designed and fabricated to provide safe and secure passage of contents contained therein aboard ocean going vessels. Such containers are generally fabricated of steel, a partial view of which is depicted in FIGS. 6 and 7. Such containers 20 have a top surface 28, a parallel bottom surface (not shown) and connecting sidewalls 29 creating a rectangularly shaped box-like structure able to withstand the rigors of intercontinental marine transport. Such containers are also provided with corner castings 25 generally having opening 24 in its top surface and openings 26 and 27 in its side surfaces. Comer castings are employed to engage lifting devices for moving containers 20 about and for receiving twist locks to hold containers together during transport.

Over time, shipping containers 20 have been used for a second purpose. Increasingly, such containers have been employed for their intended purpose of housing goods for oceanic transport but instead of returning to a far off location for continued containerization of goods, they have remained land-based and have been converted into portable and fixed storage facilities. This has oftentimes been seen as a suitable practical use for containers 20 for, otherwise, such containers would oftentimes be returned to a foreign destination empty thus requiring the payment of container shipment without the corresponding transport of merchandise. By keeping the containers as land-based storage facilities, use can be made of them while avoiding further transoceanic shipping costs.

There have been a number of creative uses for containers 20. There has developed a cottage industry known as mini-storage facilities in which a plurality of containers 20 are nested either side-by-side or stacked one on top of another enabling users to rent space created thereby as a secure means of storing valuable goods. Others have used containers 20 for promotional purposes noting that the use to which containers 20 can be made is limited only by one's imagination.

Recognizing the widely disparate uses to which containers 20 can be put, it is oftentimes deemed desirable to associate a container with a banner or signage of some type to promote such use or to identify a container to distinguish it from another or to identify its current contents. However, because such containers are made of steel and were never originally intended to act as land-based storage facilities, it has been found extremely difficult to associate a sign or banner with such containers in a simple and straightforward fashion.

It is thus an object of the present invention to provide an adaptor pole capable of being easily and conveniently applied to a suitable ISO marine container and which can remain in place for as long as is needed and yet can be easily removed while requiring no particular dedicated tooling.

These and further objects will be more readily apparent when considering the following disclosure and appended claims.

### SUMMARY OF THE INVENTION

An adaptor pole for use with an ISO marine container. The marine container is characterized as having a top, bottom and connecting sidewalls and further having at least one corner casting characterized as having openings in its top and at least one side thereof. The adaptor pole is made up of an elongated cylindrical member having a proximal end and a distal end, an abbreviated cylindrical member joined substantially perpendicularly to the elongated cylindrical member proximate the proximal end thereof, a stabilizer plate located proximate and parallel to the abbreviated cylindrical member and a barrier plate bridging the stabilizer plate and abbreviated cylindrical member. The adaptor pole is sized to enable the proximal end of the elongated cylindrical member and abbreviated cylindrical member to be removably secured within the corner casting while the stabilizer plate resides thereon to maintain the orientation of the elongated cylindrical member with respect to the ISO marine container.

### BRIEF DESCRIPTION OF THE FIGURES

FIG. 1 is a prospective view of the adaptor pole of the present invention.

FIG. 2 is a side plan view of the adaptor pole of FIG. 1.

FIG. 3 is a front plan view of the adaptor pole of FIG. 1.

FIG. 4 is a bottom plan view of the adaptor pole of FIG. 1.

FIG. 5 is a top plan view of the adaptor pole of FIG. 5.

FIGS. 6 and 7 are prospective views of a portion of a suitable ISO marine container receiving the adaptor pole of FIG. 1.

### DETAILED DESCRIPTION OF THE INVENTION

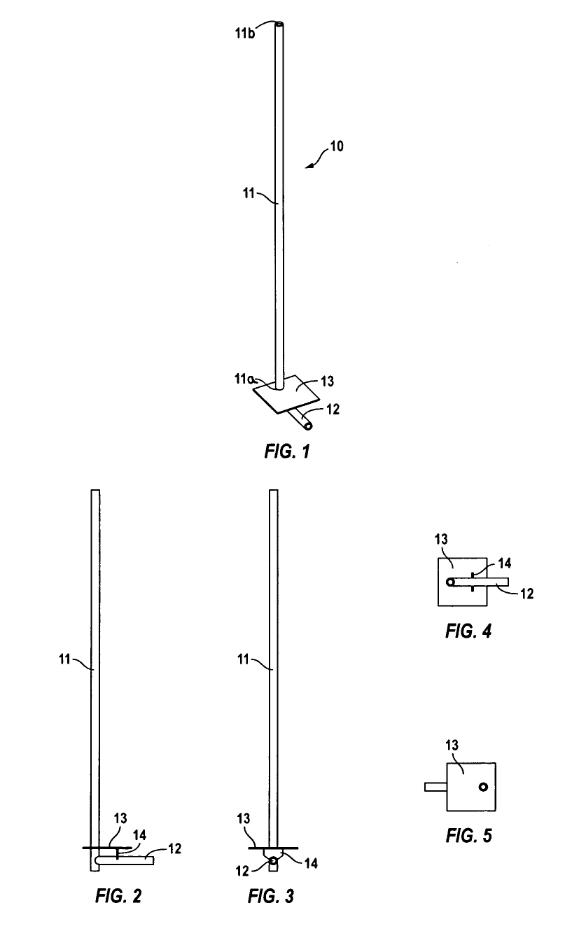

Turning first to FIG. 1, the present adaptor pole 10 is shown in order to enable an observer to appreciate its various component parts. Specifically, adaptor pole 10 is provided with elongated cylindrical member 11 having proximal end 11a and distal end 11b. Abbreviated cylindrical member 12 is joined substantially perpendicularly to elongated cylindrical member 11 proximate proximal end 11a. Stabilizer plate 13 is located proximate and parallel to abbreviated cylindrical member 12. Adaptor pole 10 further includes barrier plate 14 which is shown bridging stabilizer plate 13 and abbreviated cylindrical member 12.

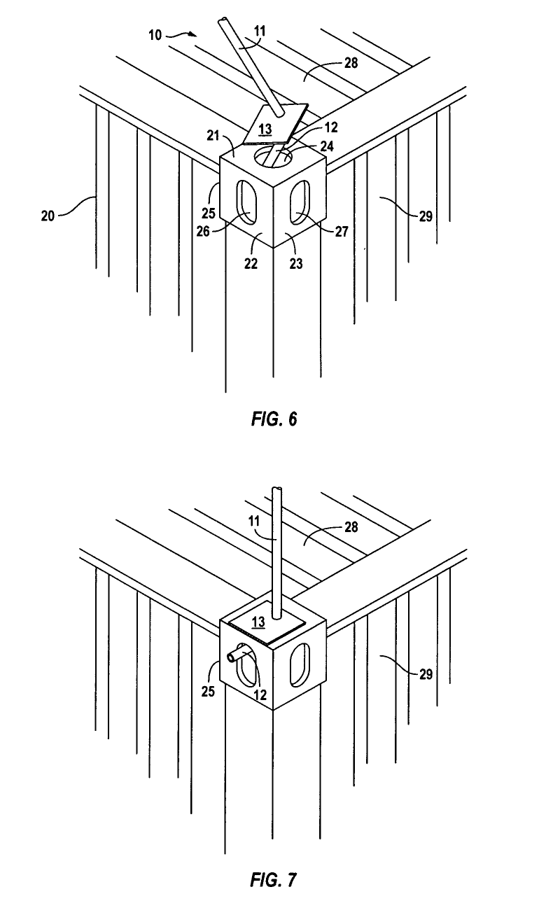

Turning next to FIGS. 6 and 7, adaptor pole 10 is being shown being joined to ISO marine container 20 at its corner casting 25. Comer casting 25 includes opening 24 on its top surface and openings 26 and 27 on its side corner surfaces.

In inserting adaptor pole 10 into corner casting 25, abbreviated cylindrical member 12 is urged into corner casting 25 through opening 24 in its top surface by tilting adaptor pole 10 diagonally and moving it towards opening 26. Adaptor pole 10 would then stop as barrier plate 14 abuts an edge defining opening 24. In doing so, adaptor pole 10 is brought to a full vertical orientation noting that abbreviated cylindrical member 12 extends through opening 26 of corner casting 25 while stabilizer plate 13 rests atop corner casting 25. The interaction of these various component parts with corner casting 25 provides an exceedingly stable joining of adaptor pole 10 to the ISO marine container which is also easily removable by reversing the steps recited above.

By providing adaptor pole 10 and engaging in the method of installing it within a suitable corner casting of an ISO marine container, one is now able to identify, if one wishes, the container and its contents. As such, if ISO marine container 20 was to be used as a storage facility, the storage facility can now be easily identified by a suitable banner appended to the distal end 11b of elongated cylindrical member 11 without having to weld, rivet or otherwise permanently affix a supporting staff or rod to such a container. Not only does this enable a user to readily change identifiers with regard to any particular container, but if the container was to go back into marine use, it could be done without having to remove identifiers which, without the benefit of the present invention, would have to be permanently affixed to it.

Discussion of the present invention and particularly in making reference to the appended figures was intended to illustrate its preferred embodiment but is not considered limiting, noting that the only limitation to the present invention involves those limitations recited in the appended claims. For example, the present invention was described in terms of cylindrical members such as elongated cylindrical member 11 and abbreviated cylindrical member 12. It should be quite apparent to anyone upon even a casual reading of the present application that such members need not have curved exteriors or circular cross sections but could be made of bar stock and similar readily available component parts without deviating from the spirit and scope of the present invention.

1. An adaptor pole for use with an ISO marine container having a top, bottom and connecting sidewalls, and further having at least one corner casting, said corner casting being characterized as having openings in its top and at least one side thereof, said adaptor pole comprising an elongated cylindrical member having a proximal end and a distal end, an abbreviated cylinder member joined substantially perpendicularly to said elongated cylindrical member proximate the proximal end thereof, a stabilizer plate located proximate and parallel to said abbreviated cylindrical member and a barrier plate bridging said stabilizer plate and abbreviated cylindrical member, said adaptor pole being sized to enable the proximal end of said elongated cylindrical member and abbreviated cylindrical member to be removably secured within said corner casting while said stabilizer plate resides thereon to maintain the orientation of said elongated cylindrical member with respect to said ISO marine container.

2. The adaptor pole of claim 1 wherein said proximal end of said elongated cylindrical member is sized to enter the opening in a top surface of said corner casting and be removably retained therein such that said elongated cylindrical member extends vertically from the top of said ISO marine container.

3. A method of removably installing an adaptor pole to a corner casting of an ISO marine container, said ISO marine container having a top, bottom and connecting sidewalls, and further having at least one corner casting, said corner casting being characterized as having openings in its top and at least one side thereof, said adaptor pole comprising an elongated cylindrical member having a proximal end and a distal end, an abbreviated cylindrical member joined substantially perpendicularly to said elongated cylindrical member proximate the proximal end thereof, a stabilizer plate located proximate and parallel to said abbreviated cylindrical member and barrier plate bridging said stabilizer plate and abbreviated cylindrical member, inserting the proximal end of said elongated cylindrical member and abbreviated cylindrical member within the top opening in said corner casting with said stabilizer plate residing thereon, a peripheral edge of said opening abutting the said barrier plate while maintaining said elongated cylindrical member to extend vertically from the top of said ISO marine container.
